(19) United States
(12) Patent Application Publication
(10) Pub. No.: US 2024/0309927 A1
(43) Pub. Date: Sep. 19, 2024

(54) BODY VALVE ASSEMBLY AND FREQUENCY SENSITIVE TYPE SHOCK ABSORBER WITH THE SAME

(71) Applicant: HL MANDO CORPORATION, Pyeongtaek (KR)

(72) Inventors: Kyudo Kim, Seoul (KR); Sewon Cho, Yongin (KR); Kwang Duk Baek, Yongin (KR)

(21) Appl. No.: 18/350,005

(22) Filed: Jul. 11, 2023

(30) Foreign Application Priority Data
Mar. 15, 2023 (KR) 10-2023-0033644

(51) Int. Cl. F16F 9/18; F16F 9/512

(52) U.S. Cl. CPC F16F 9/18; F16F 9/5126; F16F 2222/12; F16F 2228/04; F16F 2230/36

(57) ABSTRACT

A body valve assembly includes: a body valve main body having a plurality of body compression channels and a plurality of body tension channels formed to penetrate in a direction connecting a compression chamber and a reserve chamber and a body main chamber formed at ends of the plurality of body compression channels in a direction of the reserve chamber; a body pin fastened through the body valve body and having a body injection channel communicating with the compression chamber; a body main valve configured to open or close the body main chamber; a body pilot housing having one side facing the body main valve and a body pilot chamber communicating with the body injection channel on the other side; and a free piston accommodated in the body pilot chamber and configured to change a force that presses the body pilot housing according to a pressure change in the body pilot chamber.

### CROSS-REFERENCE TO RELATED APPLICATIONS

This application claims benefit and priority to Korean Patent Application No. 10-2023-0033644, filed on Mar. 15, 2023, with the Korean Intellectual Property Office, the disclosure of which is incorporated herein in its entirety by reference.

### TECHNICAL FIELD

The present disclosure relates to a body valve assembly and a shock absorber having the body valve assembly, and more specifically, to a frequency sensitive type shock absorber that can simultaneously satisfy riding comfort and steering stability by controlling a damping force differently for high and low frequencies during a compression stroke or tension stroke of a piston valve.

### BACKGROUND

In general, a damping device is installed in a vehicle to improve riding comfort by buffering shock or vibration that an axle receives from a road surface during driving, and a shock absorber is used as one of the damping devices.

The shock absorber is also called a damper. The shock absorber operates by responding to the vibration of a vehicle according to the conditions of a road surface. Here, a damping force generated in the shock absorber varies depending on an operating speed of the shock absorber. This means that the damping force will differ according to whether the shock absorber operates in a fast speed or a slow speed.

It is very important to control damping force characteristics of the shock absorber when designing a vehicle. It is because the ride comfort and driving stability of the vehicle can be can be managed by adjusting the damping force characteristics generated by the shock absorber.

For example, the shock absorber includes a cylinder filled with a working fluid such as oil, a piston rod connected to a vehicle body and reciprocating, and a piston valve coupled to the lower end of the piston rod to slide in the cylinder and control the flow of the working fluid.

Meanwhile, the piston valve commonly used in the shock absorber is designed to have constant damping characteristics at high, medium, and low speeds using a single fluid channel. Therefore, when trying to improve riding comfort by lowering the low-speed damping force, it can affect the mid-speed and high-speed damping forces.

In addition, the conventional shock absorber has a structure in which the damping force changes according to the speed change of the piston regardless of the frequency or stroke. In this way, since the damping force changes only according to the speed change of the piston and generates the same damping force in different road surface conditions, it is difficult to simultaneously satisfy the riding comfort and steering stability.

### SUMMARY

An embodiment of the present disclosure provides a body valve assembly capable of generating a damping force changed according to a change in frequency and speed and a frequency sensitive type shock absorber having the body valve assembly.

According to an embodiment of the present disclosure, there is provided a body valve assembly generating a damping force changed according to a magnitude of a frequency during a compression stroke of the frequency sensitive type shock absorber, the body valve assembly including: a body valve main body installed at the end of the frequency sensitive type shock absorber on a side of a compression chamber and having a plurality of body compression channels and a plurality of body tension channels formed to penetrate in a direction connecting the compression chamber and a reserve chamber and a body main chamber formed at ends of the plurality of body compression channels in a direction of the reserve chamber; a body pin fastened through the body valve body and having a body injection channel communicating with the compression chamber; a body main valve coupled to the body pin to open or close the body main chamber; a body pilot housing coupled to the body pin, having one side facing the body valve body with the body main valve interposed therebetween, and having a body pilot chamber communicating with the body injection channel on the other side; and a free piston accommodated in the body pilot chamber and configured to press the body pilot housing in a direction of the body main valve and change a force that presses the body pilot housing according to a pressure change in the body pilot chamber.

The body valve assembly may further include a body inlet disc interposed between the body pilot housing and the free piston. Moreover, the body pilot chamber may communicate with the body injection channel through the body inlet disc, and an inflow rate of a working fluid flowing into the body pilot chamber may be changed according to a change in frequency during a compression stroke.

The body inlet disc includes at least one body inlet disc slit formed to communicate the body injection channel formed in the body pin and the body pilot chamber so that the working fluid flows into the body pilot chamber.

The free piston may be configured so that a force pressing the body pilot housing in the direction of the body main valve during a low-frequency compression stroke is relatively greater than a force pressing the body pilot housing in the direction of the body main valve during a high-frequency compression stroke.

During a low-frequency compression stroke, the pressure in the body pilot chamber may increase while an inflow rate of a working fluid flowing into the body pilot chamber relatively increases compared to that during a high-frequency compression stroke, and as the pressure in the body pilot chamber increases, an opening rate of the body main chamber by the body main valve may become relatively small or the body main chamber may be closed while a force of the free piston pressing the body pilot housing in the direction of the body main valve increases.

Moreover, during the high-frequency compression stroke, the pressure in the body pilot chamber may decrease while the flow rate of the working fluid flowing into the body pilot chamber is relatively reduced compared to that during the low-frequency compression stroke, and as the pressure in the body pilot chamber decreases, the opening rate of the body main chamber by the body main valve may become relatively large while the force of the free piston pressing the body pilot housing in the direction of the body main valve decreases.

The body injection channel may be formed long in a slit shape along a longitudinal direction of the body pin on an outer peripheral surface of one side of the body pin.

The body valve assembly may further include a disc spring for elastically pressing the body pilot housing in the direction of the body main valve.

The body valve assembly may further include a body washer mounted on the body pin in the other direction opposite to one direction in which the free piston faces the body pilot housing, and a body spacer mounted on the body pin to maintain a minimum distance between the body washer and the body pilot housing.

According to another embodiment of the present disclosure, there is provided a frequency sensitive type shock absorber including: a first cylinder divided into a compression chamber and a rebound chamber by a piston rod reciprocating therein and a piston valve assembly mounted on the piston rod; a second cylinder surrounding the first cylinder to form a reserve chamber between the second cylinder and the first cylinder; and a body valve assembly installed at an end of the first cylinder on the side of the compression chamber to control a movement of a working fluid between the compression chamber and the reserve chamber and to generate a damping force changed according to a magnitude of a frequency during a compression stroke, in which the body valve assembly includes a body valve main body installed at the end on the side of the compression chamber and having a plurality of body compression channels and a plurality of body tension channels formed to penetrate in a direction connecting the compression chamber and a reserve chamber and a body main chamber formed at ends of the plurality of body compression channels in a direction of the reserve chamber, a body pin fastened through the body valve body and having a body injection channel communicating with the compression chamber, a body main valve coupled to the body pin to open or close the body main chamber, a body pilot housing coupled to the body pin, having one side facing the body valve body with the body main valve interposed therebetween, and having a body pilot chamber communicating with the body injection channel on the other side, and a free piston accommodated in the body pilot chamber and configured to press the body pilot housing in the direction of the body main valve and change a force that presses the body pilot housing according to a pressure change in the body pilot chamber.

The frequency sensitive type shock absorber may further include a body inlet disc interposed between the body pilot housing and the free piston. Moreover, the body pilot chamber may communicate with the body injection channel through the body inlet disc, and an inflow rate of a working fluid flowing into the body pilot chamber may be changed according to a change in frequency during a compression stroke.

The body inlet disc may include at least one body inlet disc slit formed to communicate the body injection channel formed in the body pin and the body pilot chamber so that the working fluid flows into the body pilot chamber.

The free piston may be configured so that a force pressing the body pilot housing in the direction of the body main valve during a low-frequency compression stroke is relatively greater than a force pressing the body pilot housing in the direction of the body main valve during a high-frequency compression stroke.

Moreover, during a low-frequency compression stroke, the pressure in the body pilot chamber may increase while an inflow rate of a working fluid flowing into the body pilot chamber relatively increases compared to that during a high-frequency compression stroke, and as the pressure in the body pilot chamber increases, an opening rate of the body main chamber by the body main valve may become relatively small or the body main chamber may be closed while a force of the free piston pressing the body pilot housing in the direction of the body main valve increases.

Moreover, during the high-frequency compression stroke, the pressure in the body pilot chamber may decrease while the flow rate of the working fluid flowing into the body pilot chamber is relatively reduced compared to that during the low-frequency compression stroke, and as the pressure in the body pilot chamber decreases, the opening rate of the body main chamber by the body main valve may become relatively large while the force of the free piston pressing the body pilot housing in the direction of the body main valve decreases.

The body injection channel may be formed long in a slit shape along a longitudinal direction of the body pin on an outer peripheral surface of one side of the body pin.

The body valve assembly may further include a disc spring for elastically pressing the body pilot housing in the direction of the body main valve.

The body valve assembly may further include a body washer mounted on the body pin in the other direction opposite to one direction in which the free piston faces the body pilot housing, and a body spacer mounted on the body pin to maintain a minimum distance between the body washer and the body pilot housing.

the piston valve assembly may include a piston valve main body mounted on the piston rod to control movement of the working fluid between the compression chamber and the rebound chamber, a piston main retainer coupled to the piston rod and having a piston main chamber communicating with the piston injection channel, a piston main valve coupled to the piston rod to open or close the piston main chamber, a piston pilot housing coupled to the piston rod between the piston main valve and the piston valve body and having a piston pilot chamber communicating with the piston injection channel, and a pilot valve coupled to the piston rod to cover the piston pilot chamber and configured to perform pressurization so that the piston main valve closes the piston main chamber when the pressure in the piston pilot chamber increases above a preset pressure.

The frequency sensitive type shock absorber may further include a piston inlet disc interposed between the piston pilot housing and the pilot valve. Moreover, the piston pilot chamber may communicate with the piston injection channel via the piston inlet disc, so that the inflow rate of the working fluid flowing into the piston pilot chamber during a tension stroke selectively according to the frequency is more relatively limited than the inflow rate of the working fluid flowing into the piston main chamber.

The piston inlet disc may include at least one slit formed to communicate the piston injection channel formed in the piston rod with the piston pilot chamber so that the working fluid flows into the piston pilot chamber.

During a low-frequency tension stroke, the pilot valve may be operated to press the piston main valve by the pressure of the working fluid flowing into the piston pilot chamber so that the piston main valve closes the piston main chamber, and during a high-frequency tension stroke, the pilot valve may be operated so that the force pressing the piston main valve decreases while the pressure of the working fluid flowing into the piston pilot chamber is relatively lower than the pressure of the working fluid flowing into the piston main chamber and the piston main valve is opened by the pressure of the piston main chamber.

Moreover, during a low-frequency tension stroke, as a stroke of the piston rod operates with a relatively larger width than that during a high-frequency tension stroke, the pressure in the piston pilot chamber may increase while the inflow rate of the working fluid flowing into the piston pilot chamber increases, and when the pressure in the piston pilot chamber increases above the preset pressure, the pilot valve may press the piston main valve to close the piston main chamber, and during the high-frequency tension stroke, as the stroke of the piston rod operates with a relatively smaller width than that during the low-frequency tension stroke, the pressure in the piston pilot chamber may decrease while the inflow rate of the working fluid flowing into the piston pilot chamber decreases, and when the pressure in the piston pilot chamber decreases below the preset pressure, the pilot valve may be operated so that the force of the pilot valve pressing the piston main valve decreases and the piston main valve is opened by the pressure of the piston main chamber.

A region of one surface of the piston main retainer facing the piston pilot housing may be open to form the piston main chamber, an inlet hole connected to the piston injection channel may be formed on the other surface opposite to the one surface of the piston main retainer, and the inflow hole formed on the other surface of the piston main retainer may be connected to the piston main chamber formed on the one surface of the piston main retainer.

According to one embodiment of the present disclosure, a body valve assembly and a frequency sensitive type shock absorber having the body valve assembly can generate a damping force that is effectively changed according to a change in frequency and speed.

### BRIEF DESCRIPTION OF THE DRAWINGS

FIG. 1 is a cross-sectional view illustrating a body valve assembly according to a first embodiment of the present disclosure and a frequency sensitive type shock absorber having the body valve assembly.

FIG. 2 is a perspective view illustrating a body inlet disc used in the body valve assembly of FIG. 1.

FIGS. 3 and 4 are cross-sectional views for explaining an operating state of the frequency sensitive type shock absorber of FIG. 1.

FIG. 5 is a graph illustrating action effects of the body valve assembly according to the first embodiment of the present disclosure and the frequency sensitive type shock absorber having the body valve assembly.

FIG. 6 is a cross-sectional view illustrating a piston valve assembly according to a second embodiment of the present disclosure and a frequency sensitive type shock absorber having the same.

FIG. 7 is a perspective view illustrating a piston inlet disc used in the piston valve assembly of FIG. 6.

FIGS. 8 and 9 are cross-sectional views for explaining an operating state of the frequency sensitive type shock absorber of FIG. 6.

FIG. 10 is a graph illustrating action effects of the piston valve assembly according to the second embodiment of the present disclosure and the frequency sensitive type shock absorber having the same.

FIG. 11 is a graph illustrating action effects of a frequency sensitive type shock absorber according to a third embodiment of the present disclosure.

### DETAILED DESCRIPTION

Hereinafter, with reference to the accompanying drawings, embodiments of the present disclosure will be described in detail so that a person having ordinary knowledge in the technical field to which the present disclosure belongs can easily practice it. The present disclosure may be implemented in various different forms and is not limited to the embodiments described herein.

In addition, in various embodiments, components having the identical configuration are typically referred to by the same reference numerals and described with respect to the first embodiment. In other embodiments, only configurations that differ from those described in the first embodiment will be explicitly described.

It is advised that the drawings are schematic and not drawn to scale. Relative dimensions and proportions of parts in the drawings are illustrated exaggerated or reduced in size for clarity and convenience for the understanding of the drawings, and any dimensions are illustrative only and not limiting. Moreover, similar reference numerals are used for similar structures, elements, or parts appearing in two or more drawings to indicate similar features.

Embodiments of the present disclosure represent preferred embodiments of the present disclosure. As a result, various variations of the embodiments are available within the scope of this disclosure. Therefore, the embodiments are not limited to the specific shape of the illustrated area, and include, for example, modification of the shape by manufacturing.

In addition, all technical terms and scientific terms used in the present disclosure have meanings commonly understood by those of ordinary skill in the art to which the present disclosure belongs, unless otherwise defined. All terms used in the present disclosure are selected and used for the purpose of more clearly explaining the present disclosure. Those terms are not meant to limit the scope of rights of the present disclosure.

In addition, expressions such as “comprising”, “including”, “having”, or the like used in the present disclosure should be understood in open-ended terms to including the possibility of including other embodiments, unless otherwise stated in the phrase or sentence in which the expression is included.

In addition, singular expressions described in the present disclosure may encompass plural meanings unless otherwise stated, and this applies to singular expressions described in the claims as well.

In addition, expressions such as “first” and “second” used in the present disclosure are used to distinguish a plurality of components from each other, and do not limit the order or convey importance of the components.

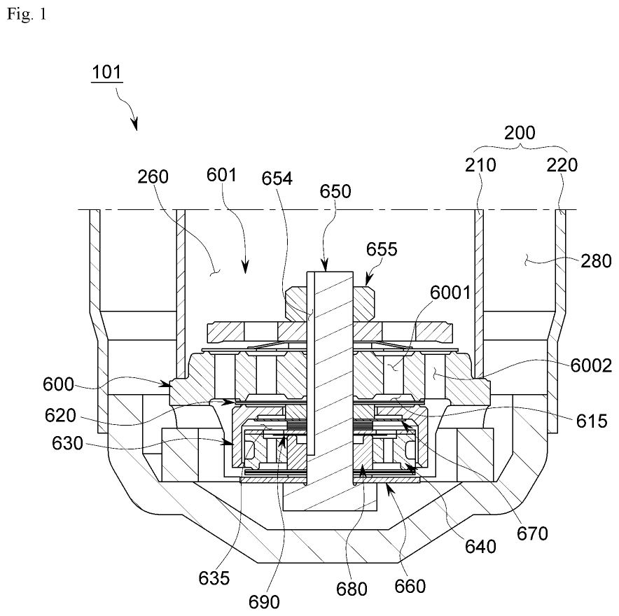

Hereinafter, a body valve assembly 601 according to a first embodiment of the present disclosure and a frequency sensitive type shock absorber 101 having the body valve assembly 601 will be described with reference to FIGS. 1 to 5. Here, the shock absorber also may be called a damper and, for example, may be installed in a vehicle and can be used to absorb and buffer shock or vibration that an axle receives from a road surface during driving.

As illustrated in FIG. 1, the frequency sensitive type shock absorber 101 includes a cylinder 200 and a body valve assembly 601 according to the first embodiment of the present disclosure.

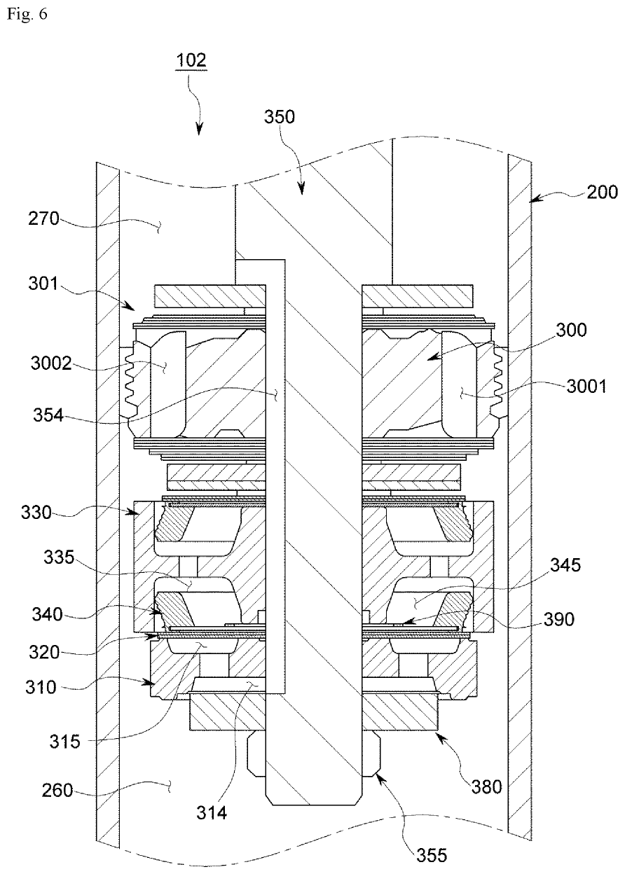

In addition, although not illustrated in FIG. 1, referring to FIG. 6 (to be described later), the frequency sensitive type shock absorber 101 may further include a piston rod 350 and a piston valve main body 300.

The cylinder 200 may have a cylindrical shape forming a space therein, and the inside of the cylinder 200 may be filled with a working fluid. Also, the cylinder 200 may include a first cylinder 210 and a second cylinder 220.

Inside the first cylinder 210, a piston valve main body 300, which will be described later, is provided to be movable up and down, in an longitudinal direction, and the inside of the first cylinder 210 may be divided into a compression chamber 260 and a rebound chamber 270 (illustrated in FIG. 6) by the piston valve main body 300. For example, based on the piston valve main body 300, an upper portion of the first cylinder 210 may become the rebound chamber 270, and a lower portion of the first cylinder 210 may become a compression chamber 260.

The second cylinder 220 may surround the first cylinder 210 with a spaced space and form a reserve chamber 280 between the first cylinder 210 and the second cylinder 220.

The piston rod 350 may reciprocate within the first cylinder 210. In addition, the piston valve main body 300 (to be described later) is mounted on one side of the piston rod 350.

The piston valve main body 300 may divide the inside of the first cylinder 210 into the compression chamber 260 and the rebound chamber 270.

The body valve assembly 601 is installed at an end of the first cylinder 210 on the compression chamber 260 side to control the movement of the working fluid between the compression chamber 260 and the reserve chamber 280. In particular, in the first embodiment of the present disclosure, the body valve assembly 601 generates a damping force that varies based on the magnitude of the frequency during a compression stroke.

Specifically, according to an embodiment, the body valve assembly 601 may include a body valve main body 600, a body pin 650, a body main valve 620, a body pilot housing 630, and a free piston 640.

In addition, the body valve assembly 601 may further include a body inlet disc 690, and may further include one or more of a body nut 655, a disc spring 670, a body spacer 660, and a body washer 680.

Accoding to an embodiment, the body valve main body 600 is installed at the end of the compression chamber 260 side to control the movement of the working fluid between the compression chamber 260 and the reserve chamber 280. In addition, the body valve main body 600 may have a plurality of body compression channels 6001 and a plurality of body tension channels 6002 formed to penetrate in a direction connecting the compression chamber 260 and the reserve chamber 280 so that the fluid can move between the compression chamber 260 and the reverse chamber 280. Therefore, during the compression stroke, the fluid inside the compression chamber 260 moves either to the rebound chamber 270 through the piston valve main body 300 or to the reserve chamber 280 through the body valve main body 600. This mechanism enables the generation of a damping force to mitigate impact or vibration.

In addition, in the first embodiment of the present disclosure, the body valve main body 600 includes a body main chamber 615 formed at an end of the plurality of body compression channels 6001 in the direction of the reserve chamber 280. That is, the body main chamber 615 may communicate with the compression chamber 260 through the body compression channel 6001. Here, the direction is based on the moving direction of the working fluid. That is, the direction of the reserve chamber 280 means a direction in which the working fluid moves toward the reserve chamber 280.

Specifically, one surface of the body valve main body 600 faces the compression chamber 260, and the body main chamber 615 may be formed on the other surface opposite to one surface of the body valve main body 600. That is, a part of the other surface of the body valve main body 600 facing the body pilot housing 630 (to be described later) may be open, and the body main chamber 615 may be formed in the opened part.

The body pin 650 is fastened through the body valve main body 600, and a body injection channel 654 communicating with the compression chamber 260 is formed. Here, the body injection channel 654 may be formed long in a slit shape along the longitudinal direction of the body pin 650 on one outer peripheral surface of the body pin 650.

The body main valve 620 is coupled to the body pin 650 to open or close the body main chamber 615. That is, the body main valve 620 may open or close the body main chamber 615 while coming into contact with or separating from the other surface of the body main valve 600.

The body pilot housing 630 is coupled to the body pin 650, in such a way that one side of the body pilot housing 630 is facing the body main valve 620. On the other side of the body pilot housig 630, there is the body pilot chamber 635, which is in communication with the body injection channel 654. That is, a section of the other side of the body pilot housing 630, which faces the free piston 640 (to be described later), can be open, and this open section forms the body pilot chamber 635. In addition, one side of the body pilot housing 630, which faces the body main valve 620, presses the body main valve 620 to cause the body main valve 620 to close the body main chamber 615 according to the operation of the free piston 640 (to be described later).

The body inlet disc 690 may be positioned between the body pilot housing 630 and the free piston 640 to establish communiation between the body pilot chamber 635 and the body injection channel 654.

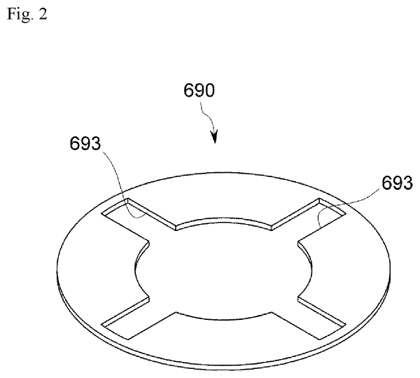

Specifically, as illustrated in FIG. 2, the body inlet disc 690 may include at least one body inlet disc slit 693 formed to establish communication between a body injection channel 654 formed in the body pin 650 with the body pilot chamber 635 so that the working fluid can flow into the body pilot chamber 635. The body inlet disc 690 may have a hollow portion at its center, through which the body pin 650 passes. According to an embodiment, the body inlet disc slit 693 may be formed by extending from the hollow portion of the body inlet disc 690 to a position where it establishes communication with the body pilot chamber 635. According to an embodiment, the body inlet disc 690 may have multiple body inlet disc slits 693. The multiple body inlet disc slits 693 may be spaced apart from each other in an circumferential direction of the of thebody inlet disc 690. According to an embodiment, the number of the body inlet disc slits 693 may be four (4) and the four body inlet disc slits 693 may form a cross shape, each being disposed perpendicualy with respect to an adjacent one. Accordingly, the body injection channel 654 and the body pilot chamber 635 can communicate with each other through the body inlet disc slit 693. In addition, the flow rate of the working fluid flowing into the body pilot chamber 635 can be controlled by adjusting the number of the body inlet disc slits 693 and the size thereof.

In this way, as the body pilot chamber 635 communicates with the body injection channel 654 through the body inlet disc 690, the inflow rate at which the working fluid flows into the body pilot chamber 635 during the compression stroke can be adjusted based on the frequency change. For example, as the pressure of the working fluid flowing into the body injection channel 654 increases, the inflow rate of the working fluid flowing into the body pilot chamber 635 decreases relatively.

Accoridng to an embodiment, the free piston 640 is accommodated in the body pilot chamber 635 and presses the body pilot housing 630 in the direction of the body main valve 620, and the force pressing the body pilot housing 630 may be changed according to the pressure change in the body pilot chamber 635.

Specifically, the free piston 640 may be configured so that a force pressing the body pilot housing 630 in the direction of the body main valve 620 (i.e., toward the body main valve 620) during the low-frequency compression stroke is relatively greater than a force pressing the body pilot housing 630 in the direction of the body main valve 620 during the high-frequency compression stroke.

For example, when the pressure in the body pilot chamber 635 is lower than the pressure in the compression chamber 260 during the high-frequency compression stroke, since the force of the free piston 640 pressing the body pilot housing 630 in the direction of the body main valve 620 decreases, the working fluid in the body main chamber 615 in communication with the compression chamber 260 can push the body main valve 620 and move to the reserve chamber 280.

At this time, the change in the pressure of the body pilot chamber 635, which decides an opening/closing of the body main valve 620, can be adjusted by the size of at least one body inlet disc slit 693 formed in the body inlet disc 690, the disc spring 670 (to be described later), or the like.

Specifically, the pressure in the body pilot chamber 635 may increase when the inflow rate of the working fluid flowing into the body pilot chamber 635 during the low-frequency compression stroke is relatively higher compared to that during the high-frequency compression stroke. As the pressure in the body pilot chamber 635 increases, it may cause a decrase in an opening rate of the body main chamber 615 by the body main valve 620 or even result in the closure of the body main chamber 615. This increase in pressure is accompanied by a corresponding increase in the force of the free piston 640, pressing the body pilot housing 630 in the direction of the body main valve 620. Accordingly, during the low-frequency compression stroke, the flow rate of the working fluid moving from the compression chamber 260 to the reserve chamber 280 is limited, resulting in a relatively high damping force.

On the other hand, the pressure of the body pilot chamber 635 may decrease when the inflow rate of the working fluid flowing into the body pilot chamber 635 during the high-frequency compression stroke is is relatively higher compared to the low-frequency compression stroke. As the pressure in the body pilot chamber 635 decreases, it may cause an increase in an opening rate of the body main chamber 615 by the body main valve 620. This derease in pressure is accompanied by a corresponding decrease in the force of the free piston 640, pressing the body pilot housing 630 in the direction of the body main valve 620. That is, a relatively low damping force is generated when the flow rate of the working fluid moving from the compression chamber 260 to the reserve chamber 280 through the body main chamber 615 increases.

Here, the reason why the pressure of the working fluid flowing into the body pilot chamber 635 is relatively lower during the high-frequency compression stroke than during the low-frequency compression stroke is because when the working fluid flows into the body pilot chamber 635, it should flow through the body inlet disc 690, such inflow rate of the working fluid is limited due to the body inlet disc 690.

For example, during the low-frequency compression stroke, the flow rate of the working fluid flowing into the body pilot chamber 635 through the body inlet disc 690 may be sufficient, such that the pressure in the body pilot chamber 635 may be smoothly formed. Accordingly, when the pressure between the pilot chamber 635 and the body main chamber 615 is in equilibrium, the body main valve 620 does not open. However, during the high-frequency compression stroke, the flow rate of the working fluid flowing into the body pilot chamber 635 is limited due to the body inlet disc 690, and so the pressure in the body pilot chamber 635 may be lower than the pressure in the body main chamber 615. Accordingly, the force of the free piston 640 pressing the body pilot housing 630 in the direction of the body main valve 620 decreases. As a result, the body main valve 620 may be open by the pressure of the body main chamber 615 and the working fluid in the compression chamber 260 can move to the reserve chamber 280 through the body main chamber 615 through the open body main valve 620.

That is, since the working fluid in the compression chamber 260 can move relatively more smoothly to the reserve chamber 280 during the high-frequency compression stroke than during the low-frequency compression stroke, the frequency sensitive type shock absorber 101 is capable of adjusting the damping force generated in response to to the change in frequency.

Accoridng to an embodiment, the disc spring 670 may be formed to elastically press the body pilot housing 630 in the direction of the body main valve 620. That is, in a state where no pressure is applied to the body pilot chamber 635, the body pilot housing 630 is in contact with the body main valve 620 by the elastic force of the disc spring 670, the body main valve 620 is in contact with the body valve main body 600, and thus, the state where the body main chamber 615 is closed may be maintained. This disc spring 670 can be used to adjust the magnitude of the damping force of the frequency sensitive type shock absorber 101.

The body washer 680 may be mounted on the body pin 650 in a direction opposite to the direction in which the free piston 640 faces the body pilot housing 630.

The body spacer 660 may be mounted on the body pin 650 to maintain a minimum distance between the body washer 680 and the body pilot housing 630.

The body nut 655 may be coupled to one end of the body pin 650 protruding through the body valve main body 600. That is, the body nut 655 can prevent the body valve main body 600 as well as the body pilot housing 630 and the free piston 640 from being separated from the body pin 650.

With this configuration, the body valve assembly 601 according to the first embodiment of the present disclosure and the frequency sensitive type shock absorber 101 having the body valve assembly 601 can generate the damping force that effectively generate a damping force that adjusts according to changes in frequency and speed.

Specifically, by controlling the inflow rate at which the working fluid that has passed through the body injection channel 654 flows into the body pilot chamber 635 and the body main chamber 615 during the compression stroke, in the low-speed section, similar damping force may be realized at low and high frequencies. Also, damping force may be adjusted according to the low and high frequencies in the mid- and high-speed section. In this way, the riding comfort and steering stability of the vehicle can be satisfied at the same time.

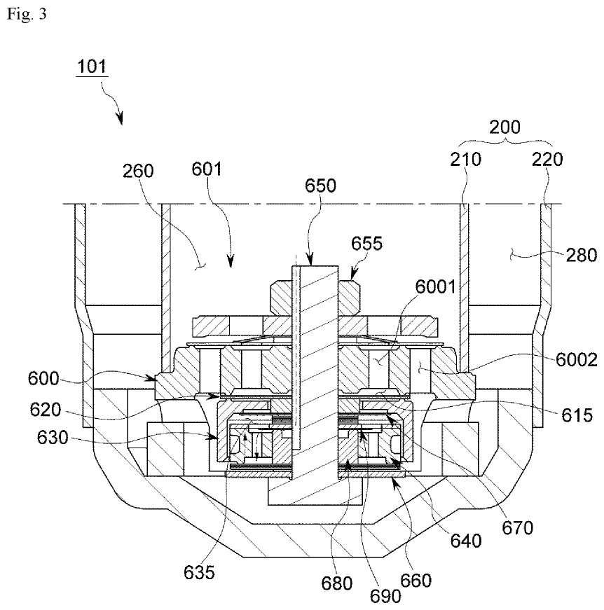

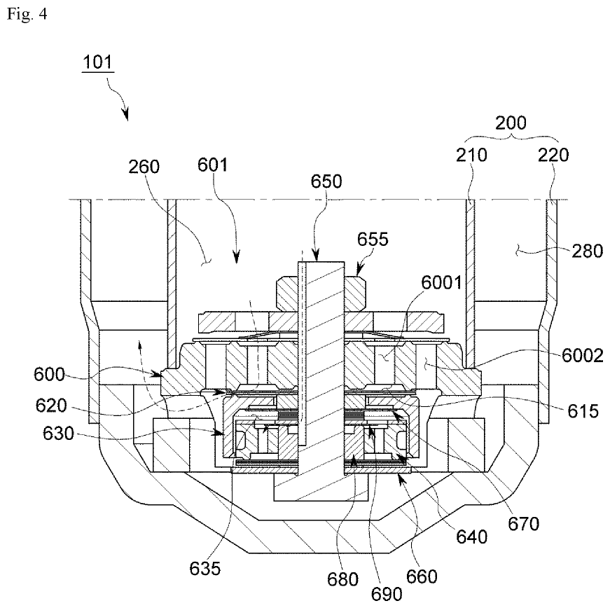

Hereinafter, with reference to FIGS. 3 and 4, the operating states of the body valve assembly 601 according to the first embodiment of the present disclosure and the frequency sensitive type shock absorber 101 having the body valve assembly 601 will be described in detail.

First, as illustrated in FIG. 3, during the low-frequency compression stroke, since the stroke of the piston rod 350 operates with a relatively larger width than during the high-frequency compression stroke, the inflow rate of the working fluid flowing into the body pilot chamber 635 increases and the pressure of the body pilot chamber 635 increases.

As such, during the low-frequency compression stroke, since the flow rate of the working fluid flowing into the body pilot chamber 635 through the body inlet disc 690 is sufficient, the pressure in the body pilot chamber 635 is relatively smoothly formed. Thus, due to the pressure balance between the body pilot chamber 635 and the body main chamber 615, the body main valve 620 does not open well. In other words, the opening of the body main valve 620 is limited or the body main valve 620 may remain closed.

That is, during the low-frequency compression stroke, the free piston 640 presses the body pilot housing 630 in the direction of the body main valve 620 by the pressure of the working fluid flowing into the body pilot chamber 635. Thereby, the body pilot housing 630 closes the body main chamber 615 or reduces the opening rate of the body main valve 620 of the body main chamber 615 by pushing the body main valve 620.

Therefore, during the low-frequency compression stroke, the flow rate of the working fluid moving from the compression chamber 260 to the reserve chamber 280 relatively decreases because the opening rate of the body main chamber 615 is reduced or the body main valve 620 of the body main chamber 615 is closed. Accordingly, the frequency sensitive type shock absorber 101 may generate a relatively high damping force during the low-frequency compression stroke.

Next, as illustrated in FIG. 4, during the high-frequency compression stroke, as the stroke of the piston rod 350 operates with a relatively smaller width than during the low-frequency compression stroke, the inflow rate of the working fluid flowing into the body pilot chamber 635 decreases and the pressure of the body pilot chamber 635 decreases.

As such, during the high-frequency compression stroke, the inflow rate of the working fluid flowing into the body pilot chamber 635 is limited due to the body inlet disc 690 and the pressure in the body pilot chamber 635 may be lower than the pressure in the body main chamber 615. Accordingly, the force of the free piston 640 pressing the body pilot housing 630 in the direction of the body main valve 620 decreases, and the body main valve 620 is relatively more easily opened by the pressure of the body main chamber 615.

That is, during the high-frequency compression stroke, the force of the free piston 640 pressing the body pilot housing 630 in the direction of the body main valve 620 decreases because the pressure of the body pilot chamber 635 decreases. Accordingly, the body main valve 620 is relatively more easily opened and the opening rate of the body main chamber 615 increases.

Therefore, during the high-frequency compression stroke, the opening rate of the body main valve 620 of the body main chamber 615 increases and the flow rate of the working fluid moving from the compression chamber 260 to the reserve chamber 280 relatively increases. In this way, the frequency sensitive type shock absorber 101 may generate a relatively low damping force during the high-frequency compression stroke.

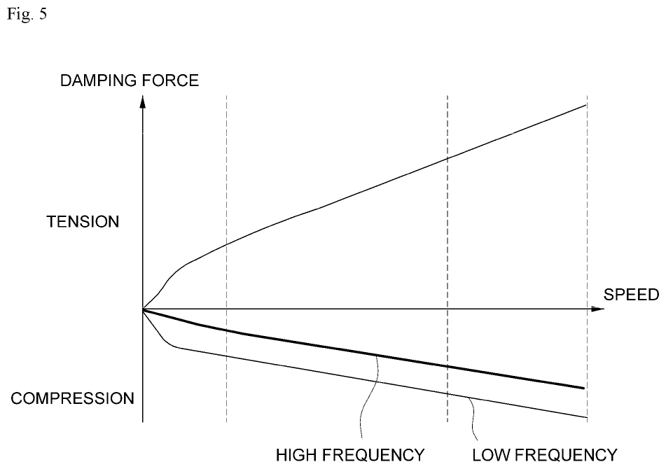

FIG. 5 is a graph illustrating the damping force of the frequency sensitive type shock absorber 101 changed during the low-frequency compression stroke and the high-frequency compression stroke. As illustrated in FIG. 5, it can be seen that the frequency sensitive type shock absorber 101 prevents the damping force from decreasing during the low-frequency compression stroke or mitigate the decreasing, and that the damping force for each frequency is changed in the medium and high-speed sections.

As described above, according to the body valve assembly 601 of the first embodiment of the present disclosure and the frequency sensitive type shock absorber 101 having the body valve assembly 601, it allows to prevent or mitigate the decrease in the steering stability due to the decrease of the damping force in the low-speed section during the low-frequency compression stroke, and improve the riding comfort by generating variable performance of the damping force for each frequency in the medium and high-speed sections.

Hereinafter, a piston valve assembly 301 and a frequency sensitive type shock absorber 102 having the piston valve assembly 301 according to a second embodiment of the present disclosure and will be described with reference to FIGS. 6 to 10.

As illustrated in FIG. 6, the frequency sensitive type shock absorber 101 includes a cylinder 200, a piston rod 350, and a piston valve assembly 301.

The cylinder 200 may have a cylindrical shape forming a space therein, and the inside of the cylinder 200 is filled with a working fluid. Here, the inside of the cylinder 200 may be divided into a compression chamber 260 and a rebound chamber 270 by the piston valve assembly 301 (to be described later). For example, based on the piston valve assembly 301, an upper portion of the cylinder 200 may become the rebound chamber 270, and a lower portion of the cylinder 200 may become a compression chamber 260.

The, the cylinder 200 of FIG. 6 may be the first cylinder 210 of the first embodiment described above.

The piston rod 350 may reciprocate within the cylinder 200. For example, one side of the piston rod 350 is located inside the cylinder 200 while the other side of the piston rod 350 extends to the outside of the cylinder 200 and may be connected to a vehicle body or wheel assembly of a vehicle. The piston valve assembly 301 (to be described later) is mounted on one side of the piston rod 350, which located inside the cylinder 200.

In addition, in the second embodiment of the present disclosure, a piston injection channel 354 that communicates with the rebound chamber 270 is formed in the piston rod 350. The piston injection channel 354 may be formed long in a slit shape along the longitudinal direction of the piston rod 350 on one outer peripheral surface of the piston rod 350.

Accoridng to the second embodiment of the present disclosure, the piston valve assembly 301 is mounted on the piston rod 350, divides the cylinder 200 into the compression chamber 260 and the rebound chamber 270, and controls the movement of the working fluid between the compression chamber 260 and the rebound chamber 270. In particular, the piston valve assembly 301 generates a damping force that varies in response to a magnitude of a frequency during a tension stroke.

Specifically, the piston valve assembly 301 includes a piston valve main body 300, a piston main retainer 310, a piston main valve 320, a piston pilot housing 330, and a pilot valve 340.

In addition, the piston valve assembly 301 may further include a piston inlet disc 390, and may further include one or more of a piston nut 355 and a piston washer 380.

The piston valve main body 300 is mounted on the piston rod 350 and controls the movement of the working fluid between the compression chamber 260 and the rebound chamber 270. That is, the piston valve main body 300 may be provided to reciprocate, inside the cylinder 200, along with the piston rod 350, while the piston rod 350 is coupled to the piston valve main body 300 by passing through the piston rod 350. The cylinder 200 is filled with the working fluid. In addition, the piston valve main body 300 may include a plurality of piston compression channels 3001 and a plurality of piston tension channels 3002 that are formed through the piston valve main body 300 in a direction connecting the compression chamber 260 and the rebound chamber 270 so that the fluid can move between the compression chamber 260 and the rebound chamber 270.

For example, during the tension stroke, the pressure of the rebound chamber 270 increases relatively higher than that of the compression chamber 260, and due to the increase in pressure of the rebound chamber 270, the working fluid filling the rebound chamber 270 may move to the compression chamber 260 through the tension channel 3002 of the piston valve main body 300. Conversely, during the compression stroke, the pressure of the compression chamber 260 increases relatively higher than that of the rebound chamber 270, and due to the increase in pressure of the compression chamber 260, the working fluid filling the compression chamber 260 may move to the rebound chamber 270 through the compression channel 3001 of the piston valve main body 300.

At this time, the piston valve assembly 301 according to the second embodiment of the present disclosure is mounted on the piston rod 350 to generate the damping force that varies in response to the magnitude of the frequency during the tension stroke.

The piston main retainer 310 may be coupled to the piston rod 350. For example, the piston main retainer 310 may be coupled to the piston rod 350 in the direction in which the piston valve main body 300 faces the compression chamber 260 with the piston pilot housing 330 (to be described later) therebetween. That is, the piston pilot housing 330 and the piston main retainer 310 may be sequentially coupled to the piston rod 350 in the direction in which the piston valve main body 300 faces the compression chamber 260.

Furthermore, the piston main retainer 310 may have a piston main chamber 315 formed to communicate with a piston injection channel 354 formed in the piston rod 350.

Specifically, one portion on one surface of the piston main retainer 310 facing the piston pilot housing 330 may be opened, and the piston main chamber 315 may be formed in the opened portion of the piston main retainer 310. In addition, an inlet hole 314, which is connected to the piston injection channel 354, may be formed on the other surface opposite to the one surface of the piston main retainer 310 facing the piston pilot housing 330. The inlet hole 314 formed on the other surface of the piston main retainer 310 may be connected to the piston main chamber 315 formed on the one surface of the piston main retainer 310 through an internal flow path in the piston main retainer 310.

In this way, in the piston main retainer 310, the piston main chamber 315 and the inlet hole 314 are formed on different surfaces separated from each other. In other words, the piston main chamber 315 and the inlet hole 314 may be formed at both end of the piston main retainer 310, facing two opposite disrections, one at one end of the piston main retainer 310 facing the piston pilot housing 330 and the other at the other end of the piston main retainer 310 facing the compressor chamber 260. By having the piston main chamber 315 and the inlet hole 314 not at a same end or at a same side of the pistion main retainer 310, the mechanical strength of the piston main retainer 310 may be improved.

In contrast to the second embodiment of the present disclosure, if both the piston main chamber 315 and the inlet hole 314 are formed on the same side of the piston main retainer 310, it can lead to a decrease in the mechanical strength of the surface where both the piston main chamber 315 and the inlet hole 314 are formed. Consequently, the main retainer 310 may become vulnerable to the load applied in the axial direction and may be more susceptible to damage.

After the piston rod 350 penetrates all of the piston valve main body 300, the piston pilot housing 330, the piston main retainer 310, the piston rod 359 may be tightened by the piston nut 355 (to be described later). Under such assembly, considerable load may be applied to the piston main retainer 310 in the axial direction. If both the piston main chamber 315 and the inlet hole 314 are formed on the same one side of the piston main retainer 310, there is a risk that the piston main retainer 310 may not be able to withstand the applied load and could potentially be damaged.

However, according to the second embodiment of the present disclosure, the piston main retainer 310 is formed with the piston main chamber 315 on one surface and the inlet hole 314 communicating with the piston inlet channel 354 on the other surface opposite to the one surface. By distributing the piston main chamber 315 and the inlet hole 314 the overall mechanical strength can be improved. Therefore, when the piston rod 350 penetrates all of the piston valve main body 300, the piston pilot housing 330, and the piston main retainer 310 and couples them through the piston nut 355, the piston main retainer 310 can stably withstand the load applied in the axial direction.

Meanwhile, piston main valve 320 is coupled to the piston rod 350 to open or close the piston main chamber 315. That is, the piston main valve 320 is configured to come into contact with or separate from one surface of the piston main retainer 310, thereby opening or closing the piston main chamber 315.

The piston pilot housing 330 is coupled to the piston rod 350 between the piston main valve 320 and the piston valve main body 300. Moreover, the piston pilot housing 330 has a piston pilot chamber 335 formed to communicate with a piston injection channel 354 formed in the piston rod 350. That is, one region of the piston pilot housing 330 is open, and the piston pilot chamber 335 may be formed by the open region.

The piston inlet disc 390 is interposed between the piston pilot housing 330 and the pilot valve 340 and establishes communicate between the piston pilot chamber 335 and the piston injection channel 354.

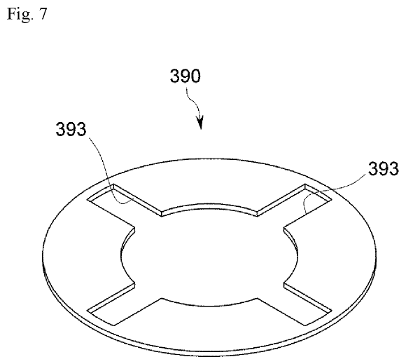

Specifically, as illustrated in FIG. 7, the piston inlet disc 390 may has a hollow portion in its center through which the piston rod 350 penetrates. The piston inlet disc 390 may further include at least one piston inlet disc slit 393 formed by extending from the hollow portion toward the peripheral of the piston inlet disc 390. The at least one piston inltet disc slit 393 may be extended from the hollow portion to a postion where it establishes communication with the piston pilot chamber 335. The at least one piston inlet disc slit 393 establishes communication between the piston injection channel 354 formed in the piston rod 350 and the piston pilot chamber 335 so that the working fluid can flow from the piston injection channel 354 into the piston pilot chamber 335. Accordingly, the piston injection channel 354 and the piston pilot chamber 335 can communicate with each other through the piston inlet disc slit 393. In addition, the flow rate of the working fluid flowing into the piston pilot chamber 335 can be controlled by adjusting the number and the size of the piston inlet disc slits 393.

In this way, since the piston pilot chamber 335 communicates with the piston injection channel 354 through the piston inlet disc 390, the inflow rate of the working fluid flowing into the piston pilot chamber 335 during the tension stroke according to the frequency may be more limited relatively than the inflow rate of the working fluid flowing into the main chamber 315.

For example, as the pressure of the working fluid flowing into the piston injection channel 354 increases, the inflow rate of the working fluid flowing into the piston pilot chamber 335 decreases compared to the inflow rate of the working fluid flowing into the piston main chamber 315.

The pilot valve 340 is coupled to the piston rod 350 is configued to cover the piston pilot chamber 335. Specifically, when the pressure of the piston pilot chamber 335 increases above the preset pressure, the pilot valve 340 presses the piston main valve 320 to close the piston main chamber 315. Here, the preset pressure may be set in various ways according to the performance required for the frequency sensitive type shock absorber 102, and may be a pressure at which the pressure of the piston main chamber 315 and the pressure of the piston pilot chamber 335 are balanced. Moreover, the preset pressure may be adjusted through the number and size of at least one piston inlet disc slit 393 formed in the piston inlet disc 390.

Specifically, during the low-frequency tension stroke, the pilot valve 340 may exert pressure on the piston main valve 320 through the working fluid introduced into the piston pilot chamber 335. This pressure causes the piston main valve 320 to close the piston main chamber 315. On the other hand, during the high-frequency tension stroke, the pressing force exerted on the piston main valve 320 decreases because the pressure of the working fluid flowing into the piston pilot chamber 335 is relatively lower comared to the pressure of the working fluid flowing into the piston main chamber 315. In this case, the pilot valve 340 is operated to open the piston main valve 320 by the pressure from the piston main chamber 335.

Here, the reason why the pressure of the working fluid flowing into the piston pilot chamber 335 is relatively lower than the pressure of the working fluid flowing into the piston main chamber 315 during the high-frequency tension stroke is because the working fluid flowing into the piston pilot chamber 335 flows through the piston inlet disc 390, and the inflow rate is limited.

For example, during the low-frequency tension stroke, the flow rate of the working fluid flowing into the piston pilot chamber 335 through the piston inlet disc 390 is sufficient. Therefore, the pressure in the piston pilot chamber 335 is relatively more smoothly formed, and thus, when the pressure between the piston pilot chamber 335 and the piston main chamber 315 is in equilibrium, the piston main valve 320 does not open. However, during the high-frequency tension stroke, the flow rate of the working fluid flowing into the piston pilot chamber 335 is limited due to the piston inlet disc 390, and the pressure in the piston pilot chamber 335 is lower than the pressure in the piston main chamber 315. Accordingly, the force of the pilot valve 340 pressing the piston main valve 320 decreases, the piston main valve 320 is opened by the pressure of the piston main chamber 315, and the working fluid in the rebound chamber 270 can move to the compression chamber 260 through the piston injection channel 354 and the piston main chamber 315.

That is, the working fluid in the rebound chamber 270 moves to the compression chamber 260 through the piston valve main body 300, the piston injection channel 354, and the piston main chamber 315 during the high-frequency tension stroke. On the other hand, during the low-frequency tension stroke, the working fluid in the rebound chamber 270 moves to the compression chamber 260 through the piston valve main body 300. In this way, the frequency sensitive type shock absorber 102 can adjust the damping force generated in response to the change in the frequency.

In addition, an accumulator 345 for maintaining and buffering the pressure of the piston pilot chamber 335 may be formed in at least one region where the pilot valve 340 faces the piston pilot housing 330.

The piston washer 380 may be mounted on the piston rod 350 to be provided between a piston nut 355 (to be described later) and the other surface of the piston main retainer 310.

The piston nut 355 may be fastened to an end of the piston rod 350 passing through the piston valve main body 300, the piston pilot housing 330, and the piston main retainer 310 in turn. That is, the piston nut 355 may prevent the piston valve assembly 301 from being separated from the piston rod 350.

With this configuration, the piston valve assembly 301 and the frequency sensitive type shock absorber 102 having the same according to the second embodiment of the present disclosure can generate the damping force that effectively adjusts in response to the change in frequency and speed.

Specifically, by controlling the inflow rate at which the working fluid, that passes through the piston injection channel 354, flows into the piston pilot chamber 335 and the piston main chamber 315 during the tension stroke, in the low-speed section, similar damping force may be realized at low and high frequencies. Also, the damping force may be adjusted according to the low and high frequencies in the mid- and high-speed section. In this way, the riding comfort and steering stability of the vehicle can be satisfied at the same time.

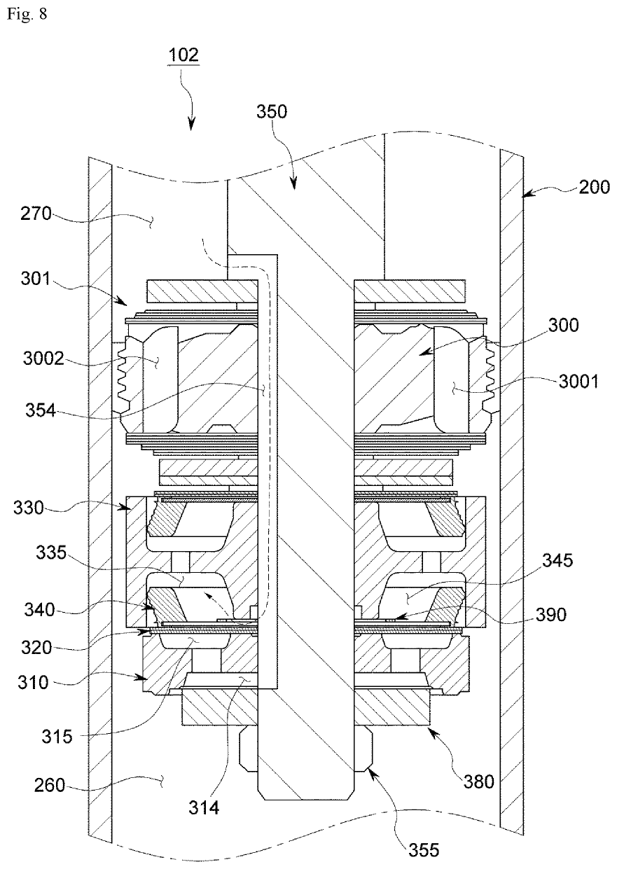

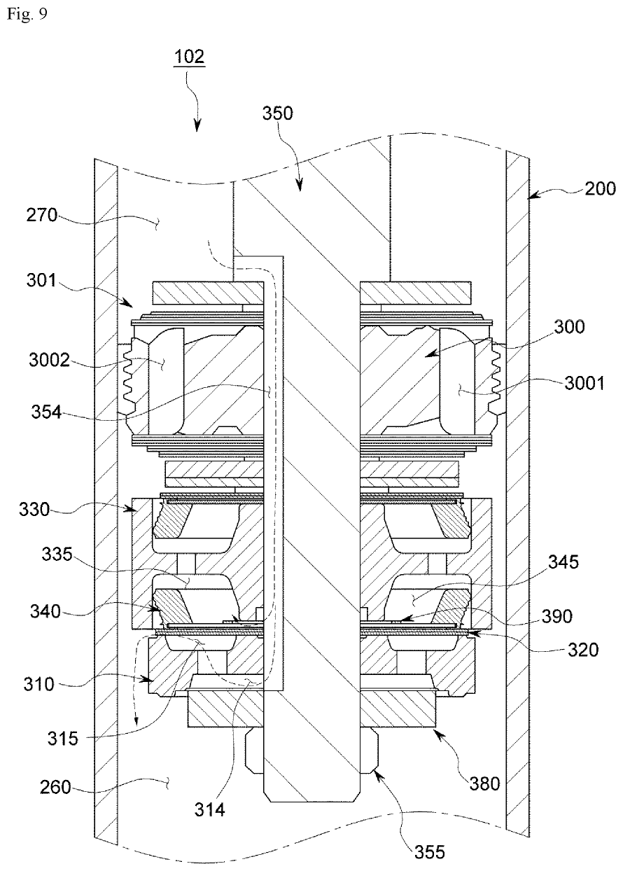

Hereinafter, with reference to FIGS. 8 and 9, the operating states of the piston valve assembly 301 according to the second embodiment of the present disclosure and the frequency sensitive type shock absorber 102 having the same will be described in detail.

First, as illustrated in FIG. 8, during the low-frequency compression stroke, since the stroke of the piston rod 350 operates with a relatively larger width than during the high-frequency compression stroke, the inflow rate of the working fluid flowing into the piston pilot chamber 335 increases and the pressure of the piston pilot chamber 335 increases.

As such, during the low-frequency compression stroke, since the flow rate of the working fluid flowing into the piston pilot chamber 335 through the piston inlet disc 390 is sufficient, the pressure in the piston pilot chamber 335 is relatively smoothly formed. Thus, due to the pressure balance between the piston pilot chamber 335 and the piston main chamber 315, the piston main valve 320 does not open. In other words, the opening of the piston main valve 320 is limited or the piston main valve 320 may remain closed.

That is, when the pressure of the piston pilot chamber 335 increases above the preset pressure during the low-frequency tension stroke, the pilot valve 340 presses the piston main valve 320 by the pressure of the working fluid flowing into the piston pilot chamber 335 and close the piston main chamber 315.

Here, the preset pressure may be set in various ways according to the performance required for the frequency sensitive type shock absorber 102, and may be the pressure at which the pressure of the piston main chamber 315 and the pressure of the piston pilot chamber 335 are balanced. Moreover, the preset pressure may be adjusted through the number and size of at least one piston inlet disc slit 393 formed in the piston inlet disc 390.

Therefore, during the low-frequency tension stroke, the working fluid in the rebound chamber 270 moves to the compression chamber 260 through the piston valve main body 300, and does not move through the piston injection channel 354 and the piston main chamber 315. Accordingly, the frequency sensitive type shock absorber 102 generates a relatively high damping force during the low-frequency tension stroke.

Next, as illustrated in FIG. 9, during the high-frequency tension stroke, as the stroke of the piston rod 350 operates with a relatively smaller width than during the low-frequency tension stroke, the inflow rate of the working fluid flowing into the piston pilot chamber 335 decreases and the pressure in the piston pilot chamber 335 decreases.

As such, during the high-frequency tension stroke, the inflow rate of the working fluid flowing into the piston pilot chamber 335 is limited due to the piston inlet disc 390 and the pressure of the piston pilot chamber 335 may be lower than the pressure of the piston main chamber 315. Therefore, the force of the pilot valve 340 pressing the piston main valve 320 decreases, the piston main valve 320 is opened by the pressure of the piston main chamber 315, and thus, the working fluid in the rebound chamber 270 can move to the compression chamber 260 through the piston injection channel 354 and the piston main chamber 315.

That is, when the pressure of the piston pilot chamber 335 decreases below the preset pressure during the high-frequency tension stroke, the force of the pilot valve 340 pressing the piston main valve 320 decreases by the pressure of the working fluid flowing into the piston pilot chamber 335, and the pilot valve 340 is operated so that the piston main valve 320 is realtivley more easily opened by the pressure of the piston main chamber 315.

Therefore, during the high-frequency tension stroke, the working fluid in the rebound chamber 270 can move to the compression chamber 260 not only through the piston valve main body 300 but also through the piston injection channel 354 and the piston main chamber 315. That is, during the high-frequency tension stroke, the piston injection channel 354 and the piston main chamber 315 form a bypass channel through which the working fluid can move from the rebound chamber 270 to the compression chamber 260.

Accordingly, the frequency sensitive type shock absorber 102 generates a relatively low damping force during the high-frequency tension stroke.

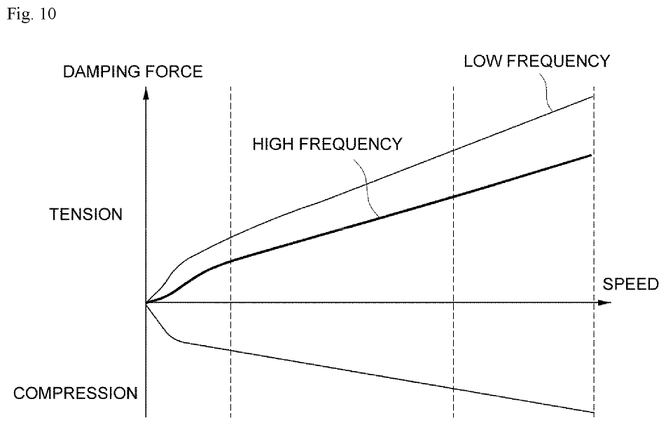

FIG. 10 is a graph illustrating a variable damping force of the frequency sensitive type shock absorber 102 during the low-frequency tension stroke and the high-frequency tension stroke. As illustrated in FIG. 10, it can be seen that the frequency sensitive type shock absorber 102 prevents the damping force from decreasing or mitigate the decreasing during the low-frequency tension stroke, and that the damping force for each frequency is changed in the medium-high speed section.

As described above, according to the piston valve assembly 301 of the second embodiment of the present disclosure and the frequency sensitive type shock absorber 102 having the piston valve assembly 301, it is allows to prevent or mitigate the decrease in the steering stability due to the decrease of the damping force in the low-speed section during the low-frequency tension stroke, and improve the riding comfort by generating variable performance of the damping force for each frequency in the medium and high-speed sections.

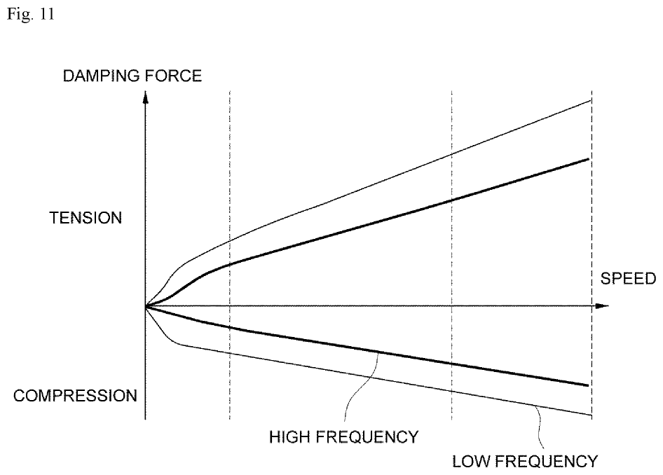

Hereinafter, a third embodiment of the present disclosure will be described with reference to FIG. 11.

The frequency sensitive type shock absorber according to the third embodiment of the present disclosure may apply both the first embodiment and the second embodiment described above. That is, the frequency sensitive type shock absorber may include both the body valve assembly 601 described above with reference to FIG. 1 in the first embodiment and the piston valve assembly 301 described above with reference to FIG. 6 in the second embodiment.

Accordingly, as illustrated in FIG. 11, the frequency sensitive type shock absorber implements a similar damping force at low and high frequencies in the low-speed section both during the compression stroke and the tension stroke, and the damping force is changed according to the low and high frequencies in the mid- and high-speed section, so that the riding comfort and steering stability of the vehicle can be satisfied at the same time.

Although the embodiments of the present disclosure have been described with reference to the accompanying drawings, those skilled in the art to which the present disclosure belongs know that the present disclosure can be implemented in other specific forms without changing its technical spirit or essential features.

Therefore, the embodiments described above should be understood as illustrative in all respects and not limiting, the scope of the present disclosure is indicated by claims, and all changes or modified forms derived from the meaning and scope of the claims and their equivalent concepts should be construed as being included in the scope of the present disclosure.

Also, it is noted that any one feature of an embodiment of the present disclosure described in the specification may be applied to another embodiment of the present disclosure.

[Detailed Description of Main Elements]

| | |
|---|---|
| 101, 102: frequency sensitive type shock | |
| absorber | |
| 200: cylinder | 210: first cylinder |
| 220: second cylinder | 260: compression chamber |
| 270: rebound chamber | 280: reserve chamber |
| 300: piston valve main body | 301: piston valve assembly |
| 310: piston main retainer | 314: inlet hole |
| 315: piston main chamber | 320: piston main valve |
| 330: piston pilot housing | 335: piston pilot chamber |
| 340: pilot valve | 350: piston rod |
| 354: piston injection channel | 355: piston nut |
| 380: piston washer | 390: piston inlet disc |
| 393: piston inlet disc slit | 600: body valve main body |
| 601: body valve assembly | 615: body main chamber |
| 620: body main valve | 630: body pilot housing |
| 635: body pilot chamber | 640: free piston |
| 650: body pin | 654: body injection channel |
| 655: body nut | 660: body spacer |
| 670: disc spring | 680: body washer |
| 690: body inlet disc | 693: body inlet disc slit |

What is claimed is:

1. A body valve assembly generating a damping force changed according to a magnitude of a frequency during a compression stroke of the frequency sensitive type shock absorber, the body valve assembly comprising:
a body valve main body installed at the end of the frequency sensitive type shock absorber on a side of a compression chamber and having a plurality of body compression channels and a plurality of body tension channels formed to penetrate in a direction connecting the compression chamber and a reserve chamber and a body main chamber formed at ends of the plurality of body compression channels in a direction of the reserve chamber;
a body pin fastened through the body valve body and having a body injection channel communicating with the compression chamber;
a body main valve coupled to the body pin to open or close the body main chamber;
a body pilot housing coupled to the body pin, having one side facing the body valve body with the body main valve interposed therebetween, and having a body pilot chamber communicating with the body injection channel on the other side; and
a free piston accommodated in the body pilot chamber and configured to press the body pilot housing in a direction of the body main valve and change a force that presses the body pilot housing according to a pressure change in the body pilot chamber.

2. The body valve assembly of claim 1, further comprising a body inlet disc interposed between the body pilot housing and the free piston,
wherein the body pilot chamber communicates with the body injection channel through the body inlet disc, and an inflow rate of a working fluid flowing into the body pilot chamber is changed according to a change in frequency during a compression stroke.

3. The body valve assembly of claim 2, wherein the body inlet disc includes at least one body inlet disc slit formed to communicate the body injection channel formed in the body pin and the body pilot chamber so that the working fluid flows into the body pilot chamber.

4. The body valve assembly of claim 2, wherein the free piston is configured so that a force pressing the body pilot housing in the direction of the body main valve during a low-frequency compression stroke is relatively greater than a force pressing the body pilot housing in the direction of the body main valve during a high-frequency compression stroke.

5. The body valve assembly of claim 1, wherein during a low-frequency compression stroke, the pressure in the body pilot chamber increases while an inflow rate of a working fluid flowing into the body pilot chamber relatively increases compared to that during a high-frequency compression stroke, and as the pressure in the body pilot chamber increases, an opening rate of the body main chamber by the body main valve becomes relatively small or the body main chamber is closed while a force of the free piston pressing the body pilot housing in the direction of the body main valve increases, and
during the high-frequency compression stroke, the pressure in the body pilot chamber decreases while the flow rate of the working fluid flowing into the body pilot chamber is relatively reduced compared to that during the low-frequency compression stroke, and as the pressure in the body pilot chamber decreases, the opening rate of the body main chamber by the body main valve becomes relatively large while the force of the free piston pressing the body pilot housing in the direction of the body main valve decreases.

6. The body valve assembly of claim 1, wherein the body injection channel is formed long in a slit shape along a longitudinal direction of the body pin on an outer peripheral surface of one side of the body pin.

7. The body valve assembly of claim 1, further comprising a disc spring for elastically pressing the body pilot housing in the direction of the body main valve.

8. The body valve assembly of claim 1, further comprising:
a body washer mounted on the body pin in the other direction opposite to one direction in which the free piston faces the body pilot housing; and
a body spacer mounted on the body pin to maintain a minimum distance between the body washer and the body pilot housing.

9. A frequency sensitive type shock absorber comprising:
a first cylinder divided into a compression chamber and a rebound chamber by a piston rod reciprocating therein and a piston valve assembly mounted on the piston rod;
a second cylinder surrounding the first cylinder to form a reserve chamber between the second cylinder and the first cylinder; and
a body valve assembly installed at an end of the first cylinder on the side of the compression chamber to control a movement of a working fluid between the compression chamber and the reserve chamber and to generate a damping force changed according to a magnitude of a frequency during a compression stroke,
wherein the body valve assembly includes
a body valve main body installed at the end on the side of the compression chamber and having a plurality of body compression channels and a plurality of body tension channels formed to penetrate in a direction connecting the compression chamber and a reserve chamber and a body main chamber formed at ends of the plurality of body compression channels in a direction of the reserve chamber,
a body pin fastened through the body valve body and having a body injection channel communicating with the compression chamber,
a body main valve coupled to the body pin to open or close the body main chamber, a body pilot housing coupled to the body pin, having one side facing the body valve body with the body main valve interposed therebetween, and having a body pilot chamber communicating with the body injection channel on the other side, and
a free piston accommodated in the body pilot chamber and configured to press the body pilot housing in the direction of the body main valve and change a force that presses the body pilot housing according to a pressure change in the body pilot chamber.

10. The frequency sensitive type shock absorber of claim 9, further comprising a body inlet disc interposed between the body pilot housing and the free piston,
wherein the body pilot chamber communicates with the body injection channel through the body inlet disc, and an inflow rate of a working fluid flowing into the body pilot chamber is changed according to a change in frequency during a compression stroke.

11. The frequency sensitive type shock absorber of claim 10, the body inlet disc includes at least one body inlet disc slit formed to communicate the body injection channel formed in the body pin and the body pilot chamber so that the working fluid flows into the body pilot chamber.

12. The frequency sensitive type shock absorber of claim 10, wherein the free piston is configured so that a force pressing the body pilot housing in the direction of the body main valve during a low-frequency compression stroke is relatively greater than a force pressing the body pilot housing in the direction of the body main valve during a high-frequency compression stroke.

13. The frequency sensitive type shock absorber of claim 9, wherein during a low-frequency compression stroke, the pressure in the body pilot chamber increases while an inflow rate of a working fluid flowing into the body pilot chamber relatively increases compared to that during a high-frequency compression stroke, and as the pressure in the body pilot chamber increases, an opening rate of the body main chamber by the body main valve becomes relatively small or the body main chamber is closed while a force of the free piston pressing the body pilot housing in the direction of the body main valve increases, and
during the high-frequency compression stroke, the pressure in the body pilot chamber decreases while the flow rate of the working fluid flowing into the body pilot chamber is relatively reduced compared to that during the low-frequency compression stroke, and as the pressure in the body pilot chamber decreases, the opening rate of the body main chamber by the body main valve becomes relatively large while the force of the free piston pressing the body pilot housing in the direction of the body main valve decreases.

14. The frequency sensitive type shock absorber of claim 9, wherein the body injection channel is formed long in a slit shape along a longitudinal direction of the body pin on an outer peripheral surface of one side of the body pin.

15. The frequency sensitive type shock absorber of claim 9, wherein the body valve assembly further includes
a disc spring for elastically pressing the body pilot housing in the direction of the body main valve,
a body washer mounted on the body pin in the other direction opposite to one direction in which the free piston faces the body pilot housing, and
a body spacer mounted on the body pin to maintain a minimum distance between the body washer and the body pilot housing.

16. The frequency sensitive type shock absorber of claim 9, wherein the piston valve assembly includes
a piston valve main body mounted on the piston rod to control movement of the working fluid between the compression chamber and the rebound chamber,
a piston main retainer coupled to the piston rod and having a piston main chamber communicating with the piston injection channel,
a piston main valve coupled to the piston rod to open or close the piston main chamber,
a piston pilot housing coupled to the piston rod between the piston main valve and the piston valve body and having a piston pilot chamber communicating with the piston injection channel, and
a pilot valve coupled to the piston rod to cover the piston pilot chamber and configured to perform pressurization so that the piston main valve closes the piston main chamber when the pressure in the piston pilot chamber increases above a preset pressure.

17. The frequency sensitive type shock absorber of claim 9, further comprising a piston inlet disc interposed between the piston pilot housing and the pilot valve,
wherein the piston pilot chamber communicates with the piston injection channel via the piston inlet disc, so that the inflow rate of the working fluid flowing into the piston pilot chamber during a tension stroke selectively according to the frequency is more relatively limited than the inflow rate of the working fluid flowing into the piston main chamber,
wherein the piston inlet disc includes at least one slit formed to communicate the piston injection channel formed in the piston rod with the piston pilot chamber so that the working fluid flows into the piston pilot chamber.

18. The frequency sensitive type shock absorber of claim 17, wherein during a low-frequency tension stroke, the pilot valve is operated to press the piston main valve by the pressure of the working fluid flowing into the piston pilot chamber so that the piston main valve closes the piston main chamber, and
during a high-frequency tension stroke, the pilot valve is operated so that the force pressing the piston main valve decreases while the pressure of the working fluid flowing into the piston pilot chamber is relatively lower than the pressure of the working fluid flowing into the piston main chamber and the piston main valve is opened by the pressure of the piston main chamber.

19. The frequency sensitive type shock absorber of claim 16, wherein during a low-frequency tension stroke, as a stroke of the piston rod operates with a relatively larger width than that during a high-frequency tension stroke, the pressure in the piston pilot chamber increases while the inflow rate of the working fluid flowing into the piston pilot chamber increases, and when the pressure in the piston pilot chamber increases above the preset pressure, the pilot valve presses the piston main valve to close the piston main chamber, and
during the high-frequency tension stroke, as the stroke of the piston rod operates with a relatively smaller width than that during the low-frequency tension stroke, the pressure in the piston pilot chamber decreases while the inflow rate of the working fluid flowing into the piston pilot chamber decreases, and when the pressure in the piston pilot chamber decreases below the preset pressure, the pilot valve is operated so that the force of the pilot valve pressing the piston main valve decreases and the piston main valve is opened by the pressure of the piston main chamber.

20. The frequency sensitive type shock absorber of claim 16, wherein a region of one surface of the piston main retainer facing the piston pilot housing is open to form the piston main chamber,
an inlet hole connected to the piston injection channel is formed on the other surface opposite to the one surface of the piston main retainer, and
the inflow hole formed on the other surface of the piston main retainer is connected to the piston main chamber formed on the one surface of the piston main retainer.
